(19) United States
(12) Patent Application Publication
(10) Pub. No.: US 2016/0171431 A1
(43) Pub. Date: Jun. 16, 2016

(54) MANAGEMENT SYSTEM FOR FOOD SAFETY AND A MANAGING METHOD FOR THE SAME

(71) Applicant: Net Alliance Co., Ltd., New Taipei City (TW)

(72) Inventor: Chi-Ching CHEN, New Taipei City (TW)

(21) Appl. No.: 14/946,558

(22) Filed: Nov. 19, 2015

(30) Foreign Application Priority Data
Dec. 12, 2014 (TW) 103143620

(51) Int. Cl. G06Q 10/08; G06Q 30/00; G06F 17/30

(52) U.S. Cl. CPC G06Q 10/087; G06F 17/30876; G06Q 30/018

(57) ABSTRACT

A management system for food safety and a managing method for the same are disclosed. The management system comprises a authentication unit, an inspection unit, a batch of identification tags, and an information device. Each identification tag is an RFID tag. Consumers obtain the product information by using the information device with an application to read the identification tag on the product. Furthermore, the unique internal code in the identification tag is used for improving the product traceability and anti-counterfeit in the present invention.

### FIELD OF THE INVENTION

The present invention relates to a management system for food safety and a managing method for the same.

### BACKGROUND OF THE INVENTION

For improving the traceability of food, some factories dispose a tag with quick response code (QR code) on each product. By using a device with QR code reader (such as a smart phone) to read the tag on the product, the browser on the device is connected to the website with the address contained in the QR code. Then, people can review the product pedigree on the official website of the product. Consequently, people can understand the composition, source, and more information of the product from the product pedigree.

However, it is easy to copy a QR code. When people use a device to read the tag with copied QR code, the browser on the device is also connected to the same website with the same address. Therefore, it is not safe enough for food safety management by using QR code system.

Consequently, how to provide an effective management system for food safety and an effective management method for food safety are urgently required by people and the industry.

### SUMMARY OF THE PRESENT INVENTION

It is an object of the present invention to provide a management system for food safety and a managing method for the same.

It is another object of the present invention to provide a management system for food safety which uses an RFID tag with a unique internal code as an identification tag for preventing the tag to be counterfeited.

It is still another object of the present invention to provide a managing method for food safety, wherein the tags and the products are one-to-one corresponded for improving the traceability and anti-counterfeit.

The present invention provides a management system for food safety, comprising: an authentication unit for accepting an application for authentications on a batch of products from a user, wherein the authentication unit has a product database and a management platform, the product database is used for storing a product information of the batch of product, the management platform is connected to the product database for management and querying of the product database; an inspection unit for performing a product inspection process according to a product classification of the batch of products; a batch of identification tags provided by the authentication unit after the product inspection process, wherein each identification tag of the batch of identification tags is an RFID tag having a unique internal code, each identification tag is corresponding to and disposed on one product of the batch of products; and an information device having a display and an application, wherein the information device is able to read the identification tag and connect to a network; wherein the unique internal codes of the batch of identification tags are stored in the product database and related to the product information of the batch of products; when the information device is used to read the identification tag disposed on one product of the batch of products and obtain the unique internal code of the identification tag, the application on the information device connects the information device to the management platform of the authentication unit by the network and displays the product information corresponding to the unique internal code on the display of the information device.

In one embodiment of the present invention, the management system further comprises a batch of fragile stickers provided by the authentication unit, wherein each fragile sticker of the batch of fragile stickers is corresponding to one product of the batch of products and adhered to a seal of the corresponding product.

In one embodiment of the present invention, each fragile sticker of the batch of fragile stickers is combined with the corresponding identification tag of the batch of identification tags.

In one embodiment of the present invention, a product pedigree of the batch of products is stored in the product database and related to the product information of the batch of products.

In one embodiment of the present invention, the application on the information device connects the information device to the management platform of the authentication unit and displays the product pedigree corresponding to the unique internal code on the display of the information device when a consumer uses the information device to read the identification tag disposed on one product of the batch of products and obtain the unique internal code of the identification tag.

In one embodiment of the present invention, the information device is selectively one of a mobile phone, an RFID reader, a computer, a personal digital assistant, or a multimedia device.

In one embodiment of the present invention, the product of the batch of products is selectively one of a food or a food ingredient.

The present invention further provides a managing method for food safety, comprising the steps of: accepting an application of a user for authentications on a batch of products; performing a product inspection process according to a product classification of the batch of products; providing a batch of identification tags, wherein each identification tag of the batch of identification tags is an RFID tag with a unique internal code, each identification tag is corresponding to one product of the batch of products; disposing each identification tag of the batch of identification tags on corresponding product of the batch of products; providing a product database; storing a product information of the batch of products and the unique internal codes of the batch of identification tags in the product database and relating the internal codes of the batch of identification tags to the product information of the batch of products; providing a information device having a display and an application, wherein the information device is able to read the identification tags and connect to a network; providing a management platform connected to the product database; and using the information device to read the identification tag disposed on one product of the batch of products and obtain the unique internal code of the identification tag, then using the application to connect the information device to the management platform by the network and display the product information corresponding to the unique internal code on the display of the information device.

In one embodiment of the present invention, the managing method further comprises a step of sealing the batch of products before the step of performing the product inspection process.

In one embodiment of the present invention, the product inspection process is a random sampling inspection process.

In one embodiment of the present invention, the managing method further comprises a step of providing a batch of fragile stickers, wherein each fragile sticker of the batch of fragile stickers is corresponding to one product of the batch of products and adhered to a seal of the corresponding product.

In one embodiment of the present invention, each fragile sticker of the batch of fragile stickers is combined with a corresponding identification tag of the batch of identification tags.

In one embodiment of the present invention, the managing method further comprises a step of storing a product pedigree of the batch of products in the product database and relating the product pedigree to the product information of the batch of products.

In one embodiment of the present invention, the application on the information device connects the information device to the management platform by the network and displays the product pedigree corresponding to the unique internal code on the display when a user or a consumer uses the information device to read the identification tag disposed on one product of the batch of products.

In one embodiment of the present invention, the information device is selectively one of a mobile phone, an RFID reader, a computer, a personal digital assistant or a multimedia device.

In one embodiment of the present invention, the product is selectively one of a food or a food ingredient.

### BRIEF DESCRIPTION OF THE DRAWINGS

FIG. 1 is a schematic diagram of a management system for food safety in accordance with one embodiment of the present invention.

FIG. 2 is a schematic diagram showing an identification tag in accordance with one embodiment of the present invention disposed on a product.

FIG. 3 is a schematic diagram showing an identification tag in accordance with another embodiment of the present invention disposed on a product.

FIG. 4 is a flow chart illustrating a managing method for food safety in accordance with one embodiment of the present invention.

### DETAILED DESCRIPTION OF THE PREFERRED EMBODIMENTS

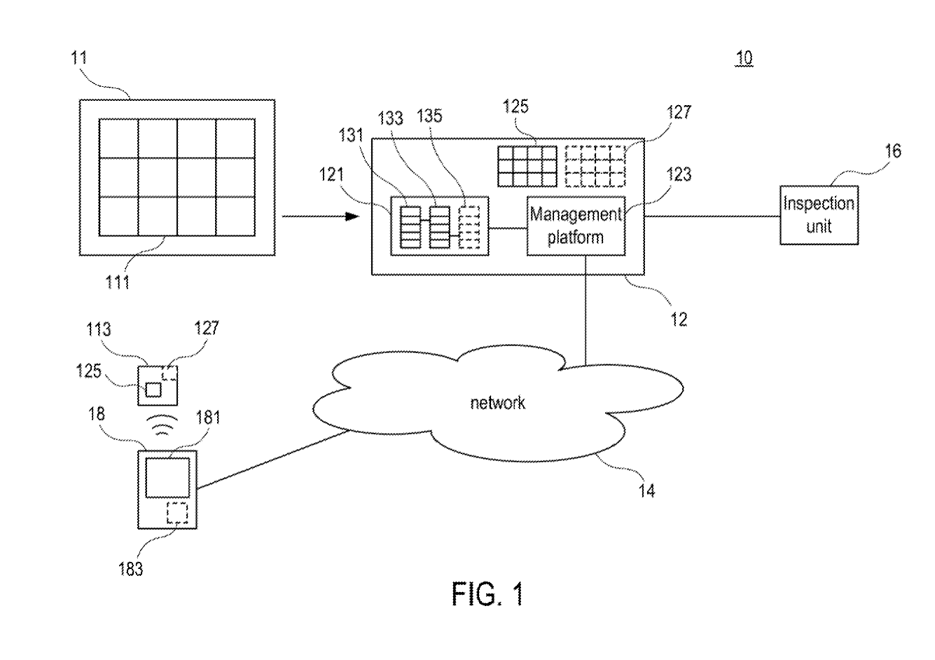

Please refer to FIG. 1, there is shown a management system for food safety 10 in accordance with one embodiment of the present invention. In one embodiment of the present invention, the management system 10 comprises an authentication unit 12, an inspection unit 16, a batch of identification tags 125 and an information device 18. Users can apply to the authentication unit 12 for authentications on the batch of products 11. The batch of products 11 comprises a plurality of products 111. The authentication unit 12 comprises a product database 121 and a management platform 123. The product database 121 is used for storing product information of the batch of product 11. The management platform 123 is connected to the product database 123 for management and querying of the product database 123.

The inspection unit 16 performs a product inspection process according to the product classification of the batch of products 11. After product inspection process, the authentication unit 12 provides a batch of identification tags 125, wherein each identification tag 125 is an RFID tag storing a unique internal code 133. The identification tags 125 are corresponding to and disposed on the qualified products 111 of the batch of products 11. The unique internal codes 133 of the identification tags 125 are stored in product database 121 and corresponding to the product information 131 of the batch of product 11. The information device 18 comprises a display 181 and an application 183 and is able to read the identification tag 125 and connect to a network 14.

When a consumer uses the information device 18 to read the identification tag 125 disposed on the product 113 and obtain the unique internal code 133 of the identification tag 125, the application 183 on the information device 18 connects the information device 18 to the management platform 123 of the authentication unit 12 by the network 14 and displays the product information 131 corresponding to the unique internal code 133 on the display 181 of the information device 18.

In one embodiment of the present invention, the authentication unit 12 can also provide a batch of fragile stickers 127 according to the batch of products 11. Each fragile sticker 127 is corresponding to one product 111 of the batch of products 11. Each fragile sticker 127 is adhered to the seal of the corresponding product 113 for recognizing whether the product 113 is unsealed. If the fragile sticker 127 on the product 113 is broken, that means that the product 113 is unsealed. On the contrary, if the fragile sticker 127 is integral, the product 113 is not unsealed.

In one embodiment of the present invention, the product database 121 comprises the product pedigree 135 of the batch of product 11. When a consumer uses the information device 18 to read the identification tag 125 disposed on the product 113 and obtain the unique internal code 133 of the identification tag 125, the application 183 on the information device 18 connects the information device 18 to the management platform 123 of the authentication unit 12 by the network 14 and displays the product pedigree 135 corresponding to the unique internal code 133 on the display 181 of the information device 18.

In one embodiment of the present invention, the information device 18 is selectively one of a mobile phone, an RFID reader, a computer, a Personal Digital Assistant (PDA), or a multimedia device.

In one embodiment of the present invention, the product 111 is selectively one of a food or a food ingredient.

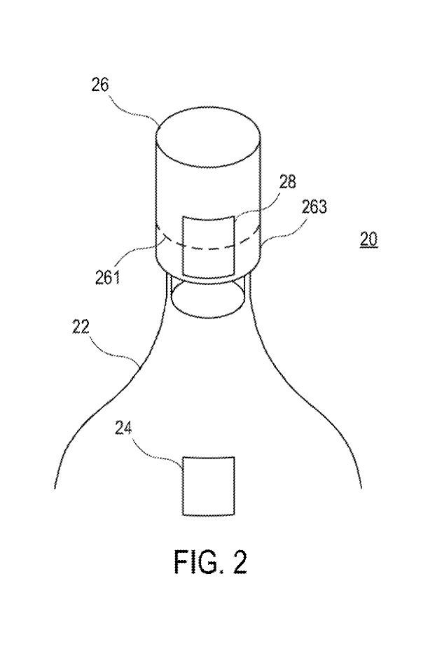

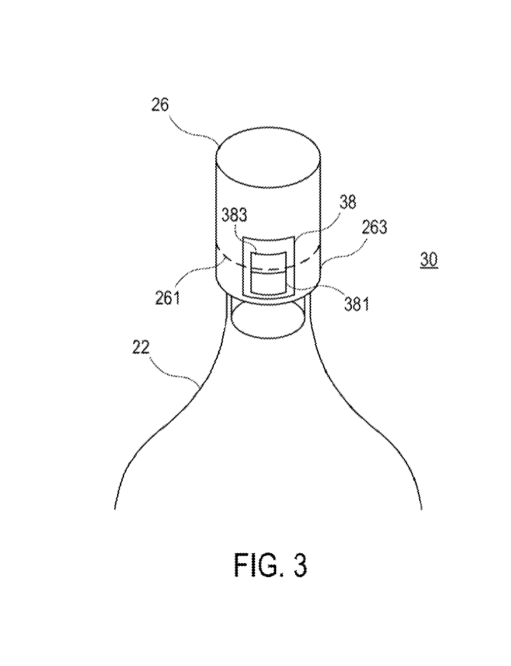

Please refer to FIGS. 2 and 3, there are shown identification tags in accordance with different embodiments of the present invention disposed on products. In the embodiments of FIGS. 2 and 3, the bottled products 20 and 30 are used for purposes of illustration, the products in the present invention are not limited to the described embodiments.

In one embodiment of the present invention, the identification tag 24 is disposed on the container 22 of the product 20. Consumers use an information device to read the identification tag 24, and the product information of the product 20 can be shown on the information device for querying. Furthermore, a fragile sticker 28 can be disposed on the seal of the product 20. For example, the seal of the product 20 in the present embodiment is on the cap 26. The cap 26 has a tearing line 261 and a cuff 263. The fragile sticker 28 is disposed on the tearing line 261 of the cap 26, as shown in FIG. 2. If the product 20 has been unsealed, that means the cap 26 has been torn off at the tearing line 261, the fragile sticker 28 must be broken. Consequently, if the fragile sticker 28 is integral, the product 20 is ensured not being unsealed.

In one embodiment of the present invention, the fragile sticker and the identification tag can be combined together. The identification tag 38 of the present embodiment comprises an RFID tag 381 and a fragile portion 383. For the present embodiment, the identification tag 38 is disposed on the cap 26 of the product 30, wherein the RFID tag 381 is disposed on the cuff 263 and the fragile portion 383 is disposed across the tearing line 261, as shown in FIG. 3.

In the present embodiment, only one identification tag 38 is needed for product 30 traceability and anti-counterfeit. Consumers can firstly observe that whether the identification tag 38 is integral or not. If the identification tag 38 is integral, the product 30 is ensured not being unsealed, and the contents in the product 30 would not be changed or mixed with dopants. If the fragile portion 383 of the identification tag 38 is broken, the product 30 may be unsealed.

After confirming that the identification tag 38 is integral, consumers can use an information device to read the RFID tag 381 of the identification tag 38, the application on the information device connects the information device to the management platform of the authentication unit by network and display the product information corresponding to the unique internal code on the display of the information device.

Since the RFID tag 381 is disposed on the cuff 263 of the cap 26, even though the consumer purchases and unseals the product 30, the RFID tag 381 is still integral. People can also use an information device to read the RFID tag 381 for querying the product information of the product 30.

In one embodiment of the present invention, the identification tag 38 is made fragile for providing product traceability and anti-counterfeit before the product 30 is unsealed. In the present embodiment, the identification tag 38 will be damaged after unsealing the product 30. The RFID tag 381 of the identification tag 38 is also damaged and becomes unreadable for the information device.

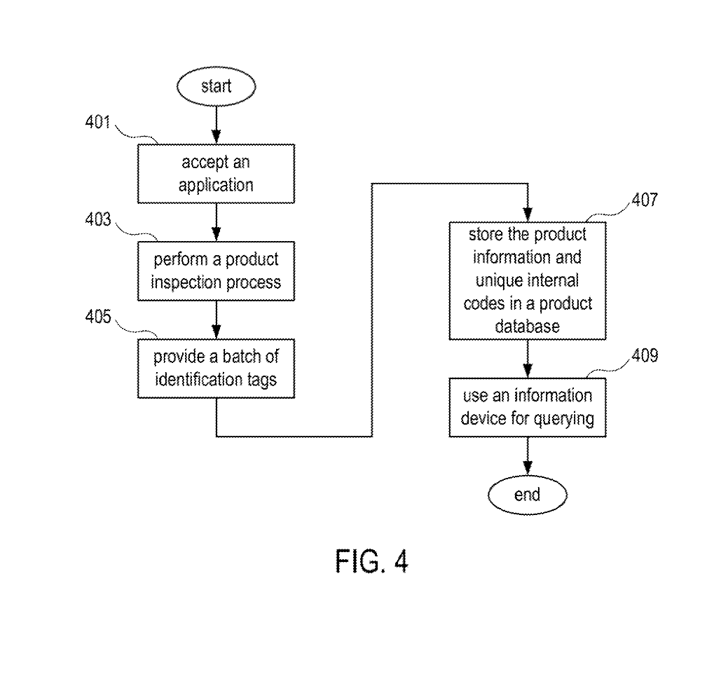

FIG. 4 is a flow chart that illustrates a managing method for food safety in accordance with one embodiment of the present invention. In the managing method of the present invention, the authentication unit accepts the application of a user for authentications on a batch of products firstly, as shown in step 401. The inspection unit performs a product inspection process according to the product classification of the batch of product, as shown in step 403. After product inspection process, the authentication unit provides a batch of identification tags, wherein each identification tag is corresponding to and disposed on one of the batch of product, as shown in step 405. Each identification tag is an RFID tag with a unique internal code.

The authentication unit provides a product database, stores the product information of the batch of product and the unique internal codes of the batch of identification tags in the product database, and relates the unique internal codes of the batch of identification tags to the product information of the batch of product, as shown in step 407. The authentication unit further provides a management platform connected to the product database for management and querying of the product database.

Finally, a user or a consumer provides an information device with a display and an application to read the identification tag disposed on one of the products and obtain the unique internal code of the identification, the application on the information device connects the information device to the management platform of the authentication unit by the network and displays the product information corresponding to the unique internal code on the display of the information device, as shown in step 409.

In one embodiment of the present invention, the managing method of the present invention further comprises a step of sealing the batch of products before the step of performing the product inspection process. This prevents the products from being changed or mixed with dopants after the step of performing the product inspection process.

In one embodiment of the present invention, the product inspection process is a random sampling inspection process. Since the batch of products has been sealed, an appropriate proportion of random sampling inspection is effective. Consequently, the cost and time required for product inspection process are greatly reduced.

In one embodiment of the present invention, the managing method further comprises a step of providing a batch of fragile stickers. Each fragile sticker is corresponding to one product of the batch of products and is adhered to the seal of the corresponding product. Since the fragile sticker is fragile, if the product has been unsealed, the fragile sticker must be broken. Consumers can recognize the integrality of the product by the fragile sticker.

In one embodiment of the present invention, the fragile sticker and the identification tag are combined together. For the present embodiment, only one identification tag is needed for product traceability and anti-counterfeit.

In one embodiment of the present invention, the managing method further comprises a step of storing the product pedigree of the batch of products in the product database and relating the product pedigree of the batch of products to the product information of the batch of products.

In one embodiment of the present invention, when using the information device to read the identification tag disposed on one of the product and obtain the unique internal code of the identification tag, the application on the information device connects the information device to the management platform of the authentication unit by the network and displays the product pedigree corresponding to the unique internal code on the display of the information device.

In one embodiment of the present invention, the information device is selectively one of a mobile phone, an RFID reader, a computer, a PDA, or a multimedia device.

In one embodiment of the present invention, the product is selectively one of a food or a food ingredient.

By using the management system for food safety or the managing method for the same, the product traceability and anti-counterfeit are improved.

Although particular embodiments of the invention have been described in detail for purposes of illustration, various modifications and enhancements may be made without departing from the scope of the invention specified by the claims.

What is claimed is:

1. A management system for food safety, comprising:
an authentication unit for accepting an application for authentications on a batch of products from a user, wherein the authentication unit has a product database and a management platform, the product database is used for storing a product information of the batch of product, the management platform is connected to the product database for management and querying of the product database;
an inspection unit for performing a product inspection process according to a product classification of the batch of products;
a batch of identification tags provided by the authentication unit after the product inspection process, wherein each identification tag of the batch of identification tags is an RFID tag having a unique internal code, each identification tag is corresponding to and disposed on one product of the batch of products; and
an information device having a display and an application, wherein the information device is able to read the identification tag and connect to a network;
wherein the unique internal codes of the batch of identification tags are stored in the product database and related to the product information of the batch of products;
when the information device is used to read the identification tag disposed on one product of the batch of products and obtain the unique internal code of the identification tag, the application on the information device connects the information device to the management platform of the authentication unit by the network and displays the product information corresponding to the unique internal code on the display of the information device.

2. The management system as claimed in claim 1, further comprising a batch of fragile stickers provided by the authentication unit, wherein each fragile sticker of the batch of fragile stickers is corresponding to one product of the batch of products and adhered to a seal of the corresponding product.

3. The management system as claimed in claim 2, wherein each fragile sticker of the batch of fragile stickers is combined with the corresponding identification tag of the batch of identification tags.

4. The management system as claimed in claim 1, wherein a product pedigree of the batch of products is stored in the product database and related to the product information of the batch of products.

5. The management system as claimed in claim 4, wherein the application on the information device connects the information device to the management platform of the authentication unit and displays the product pedigree corresponding to the unique internal code on the display of the information device when a consumer uses the information device to read the identification tag disposed on one product of the batch of products and obtain the unique internal code of the identification tag.

6. The management system as claimed in claim 1, wherein the information device is selectively one of a mobile phone, an RFID reader, a computer, a personal digital assistant, or a multimedia device.

7. The management system as claimed in claim 1, wherein the product of the batch of products is selectively one of a food or a food ingredient.

8. A managing method for food safety, comprising the steps of:
accepting an application of a user for authentications on a batch of products;
performing a product inspection process according to a product classification of the batch of products;
providing a batch of identification tags, wherein each identification tag of the batch of identification tags is an RFID tag with a unique internal code, each identification tag is corresponding to one product of the batch of products;
disposing each identification tag of the batch of identification tags on corresponding product of the batch of products;
providing a product database;
storing a product information of the batch of products and the unique internal codes of the batch of identification tags in the product database and relating the internal codes of the batch of identification tags to the product information of the batch of products;
providing a information device having a display and an application, wherein the information device is able to read the identification tags and connect to a network;
providing a management platform connected to the product database; and
using the information device to read the identification tag disposed on one product of the batch of products and obtain the unique internal code of the identification tag, then using the application to connect the information device to the management platform by the network and display the product information corresponding to the unique internal code on the display of the information device.

9. The managing method as claimed in claim 8, further comprising a step of sealing the batch of products before the step of performing the product inspection process.

10. The managing method as claimed in claim 9, wherein the product inspection process is a random sampling inspection process.

11. The managing method as claimed in claim 8, further comprising a step of providing a batch of fragile stickers, wherein each fragile sticker of the batch of fragile stickers is corresponding to one product of the batch of products and adhered to a seal of the corresponding product.

12. The managing method as claimed in claim 11, wherein each fragile sticker of the batch of fragile stickers is combined with a corresponding identification tag of the batch of identification tags.

13. The managing method as claimed in claim 8, further comprising a step of storing a product pedigree of the batch of products in the product database and relating the product pedigree to the product information of the batch of products.

14. The managing method as claimed in claim 13, wherein the application on the information device connects the information device to the management platform by the network and displays the product pedigree corresponding to the unique internal code on the display when a user or a consumer uses the information device to read the identification tag disposed on one product of the batch of products.

15. The managing method as claimed in claim 8, wherein the information device is selectively one of a mobile phone, an RFID reader, a computer, a personal digital assistant or a multimedia device.

16. The managing method as claimed in claim 8, wherein the product is selectively one of a food or a food ingredient.
